(19) United States
(12) Patent Application Publication
(10) Pub. No.: US 2026/0067181 A1
(43) Pub. Date: Mar. 5, 2026

(54) Monitored Learning System

(71) Applicant: Ramin Bolouri, Concord, CA (US)

(72) Inventor: Ramin Bolouri, Concord, CA (US)

(21) Appl. No.: 19/313,749

(22) Filed: Aug. 28, 2025

Related U.S. Application Data
(60) Provisional application No. 63/688,228, filed on Aug. 28, 2024.

(51) Int. Cl. H04L 41/5041; G06N 20/00; G06V 10/80; G06V 20/70; H04L 67/50

(52) U.S. Cl. CPC H04L 41/5048; G06N 20/00; G06V 10/803; G06V 20/70; H04L 67/535

(57) ABSTRACT

A Monitored Learning System captures a user's multi-modal interactions across applications and devices—including GUI events, keystrokes, pointer movements, screen content, and audio—to train models that predict and perform user-consistent actions. A User Interaction Monitor records event, visual, and audio data; a Data Processing Unit aggregates and enriches the data via time alignment, optical character recognition, GUI element recognition, and speech-to-text to produce structured training datasets; an AI Training Engine learns policies that generalize the user's workflows; and an AI Simulation & Deployment module executes predicted actions on target applications, optionally with scheduling and feedback logging for continual improvement. The system enables a personalized automation agent that adapts to variations in content and interface layout while respecting privacy through configurable redaction.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A SEQUENCE LISTING, A LARGE TABLE, OR A COMPUTER PROGRAM LISTING APPENDIX ON READ-ONLY OPTICAL DISC Not Applicable.

### BACKGROUND OF THE INVENTION

### Field of the Invention

The present disclosure relates to computer-implemented systems and methods for learning from and simulating user interactions with graphical user interfaces across applications and devices, and more particularly to multi-modal data capture and machine-learning-based automation that imitates a specific user's behavior.

### Description of Related Art

Robotic process automation (RPA), process mining, and prior “programming-by-demonstration” techniques record GUI events and/or screenshots to derive scripts for repeatable workflows. While effective in scoped scenarios, such solutions generally (i) focus on single-application or single-device contexts, (ii) rely on explicit “recording sessions,” and (iii) lack incorporation of audio context (e.g., voice commands, ambient speech) in learning behavioral policies.

Research systems have used screenshots plus mouse/keyboard traces to synthesize scripts and occasionally ask clarifying questions; template-matching tools (e.g., image-based clickers) replay clicks keyed to static visual anchors. These techniques struggle to generalize across UI changes, do not fuse multimodal signals (vision, text, audio), and typically do not construct a personalized agent that adapts to new but similar tasks in a user-specific style.

Accordingly, there is a need for an integrated, cross-device system that continuously captures multi-modal interaction data (GUI events, screen content, and audio), transforms it into structured training data, and trains one or more models capable of predicting and enacting user-consistent actions across diverse applications without brittle, task-specific scripting.

### BRIEF SUMMARY OF THE INVENTION

Disclosed is a Monitored Learning System (MLS) comprising: a User Interaction Monitor (UIM) executable on one or more devices to capture user interactions (e.g., GUI events, keystrokes, pointer movements), screen content data (e.g., screenshots or pixel regions), and audio (e.g., voice commands, meeting audio); a Data Processing Unit (DPU) to aggregate, time-align, cleanse, and enrich such data via optical character recognition (OCR), speech-to-text, and object recognition of GUI elements; an AI Training Engine (ATE) to train multi-modal models that generalize the user's task patterns; and an AI Simulation & Deployment (ASD) module to execute predicted actions on target applications, locally or via cloud services, optionally with scheduling and continuous feedback for online improvement.

The MLS distinguishes over prior approaches through: (i) explicit integration of audio with visual and event modalities, (ii) seamless cross-device capture and aggregation, (iii) policy-learning that adapts to new instances of tasks in a user's style, and (iv) a closed-loop deployment that monitors the agent's actions and re-ingests them for continual learning.

### BRIEF DESCRIPTION OF THE SEVERAL VIEWS OF THE DRAWING

FIG. 1 is a block diagram of an example Monitored Learning System (MLS) environment showing cross-device capture on user devices and core system components within a cloud boundary.

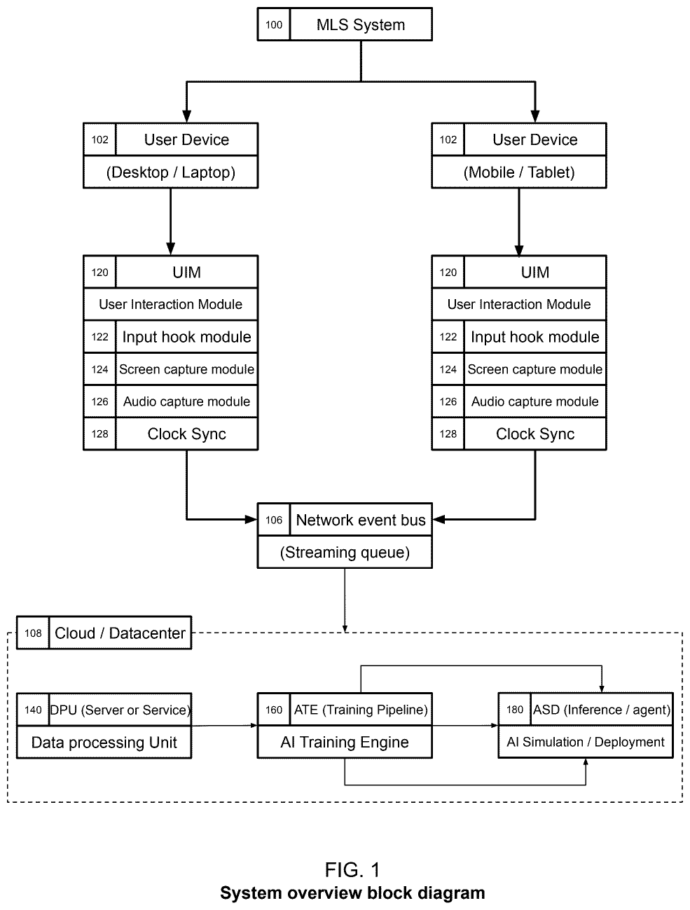

FIG. 2 is a pipeline diagram illustrating end-to-end data flow from multi-modal capture through preprocessing, model training, deployment, and closed-loop feedback.

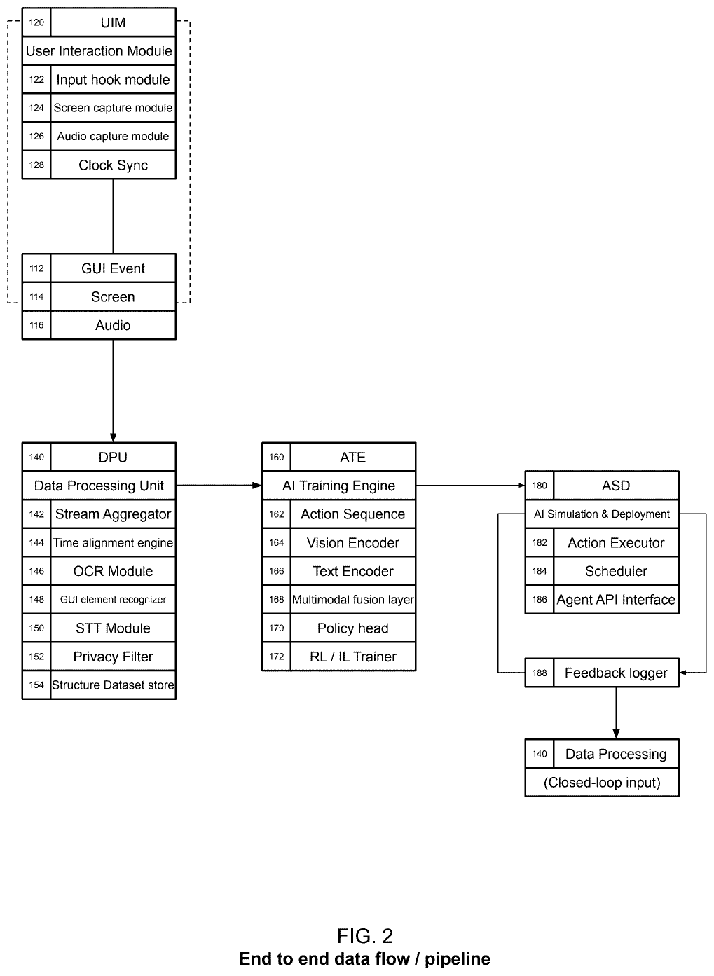

FIG. 3 is a component diagram of a User Interaction Monitor (UIM) executing on a user device, including input-hook, screen-capture, audio-capture, and clock-synchronization modules.

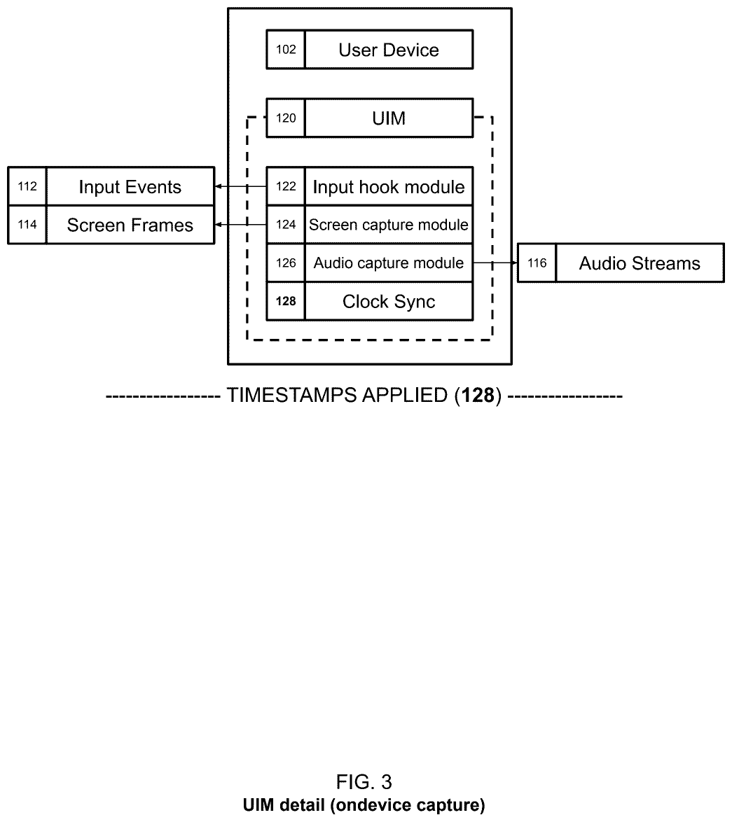

FIG. 4 is a block diagram of a Data Processing Unit (DPU) performing stream aggregation, time alignment, optical character recognition, graphical user-interface element recognition, speech-to-text, privacy filtering, and dataset storage.

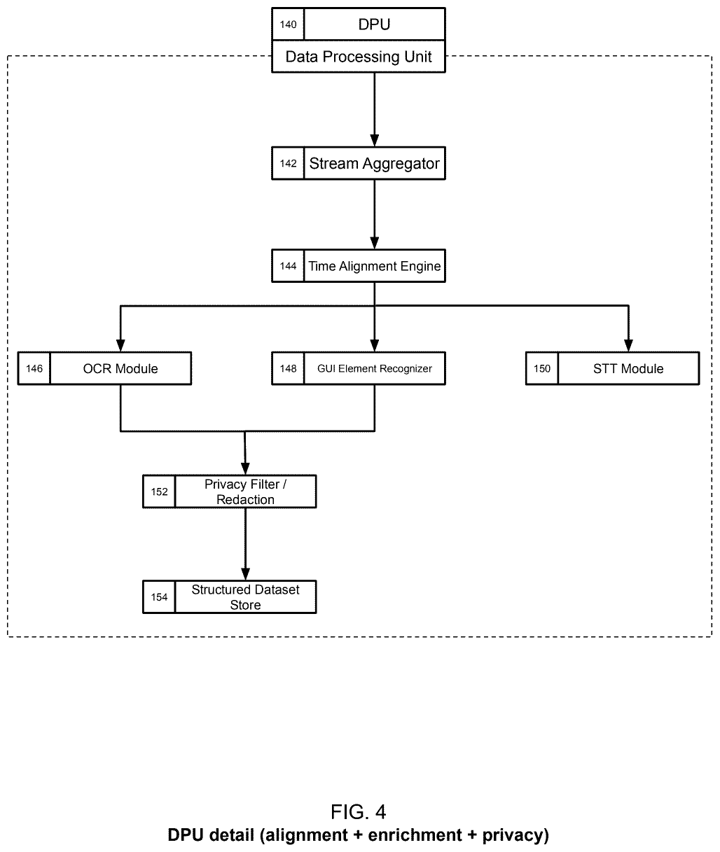

FIG. 5 is a block diagram of an AI Training Engine (ATE) including an action-sequence model, a vision encoder, a text encoder, multimodal fusion, a policy head, and a reinforcement/imitation-learning trainer.

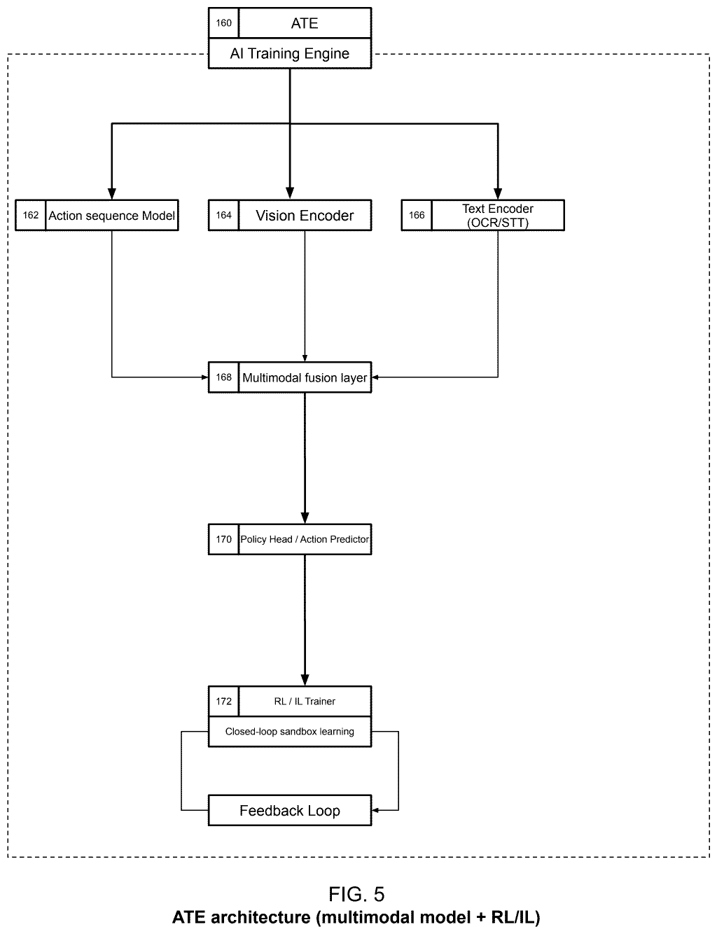

FIG. 6 is a block diagram of an AI Simulation & Deployment (ASD) module executing predicted actions in target applications, with a scheduler, integration interface, and feedback logging.

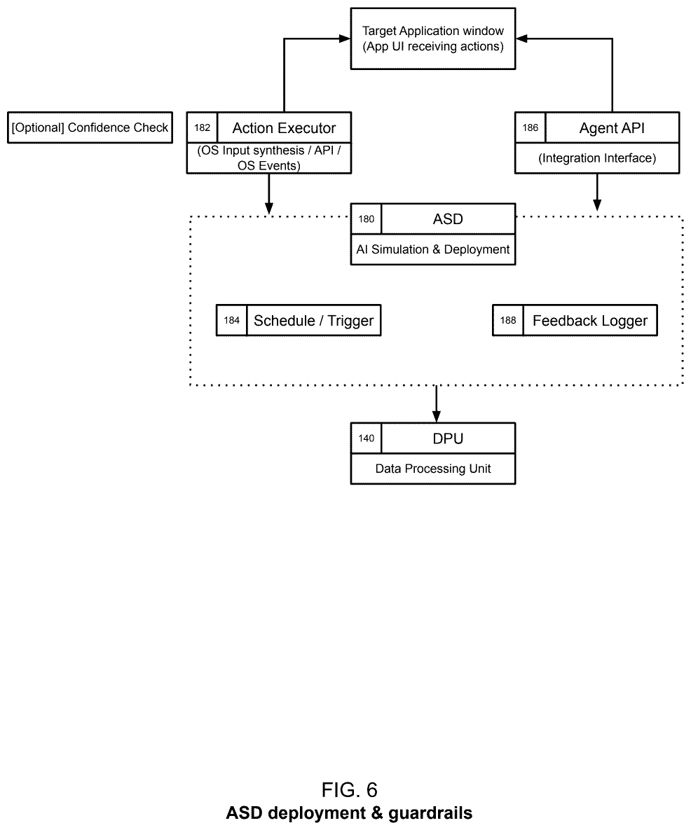

FIG. 7 is a sequence diagram illustrating multi-device operation via a network event bus in an example scenario that routes a desktop signal to a mobile reply workflow.

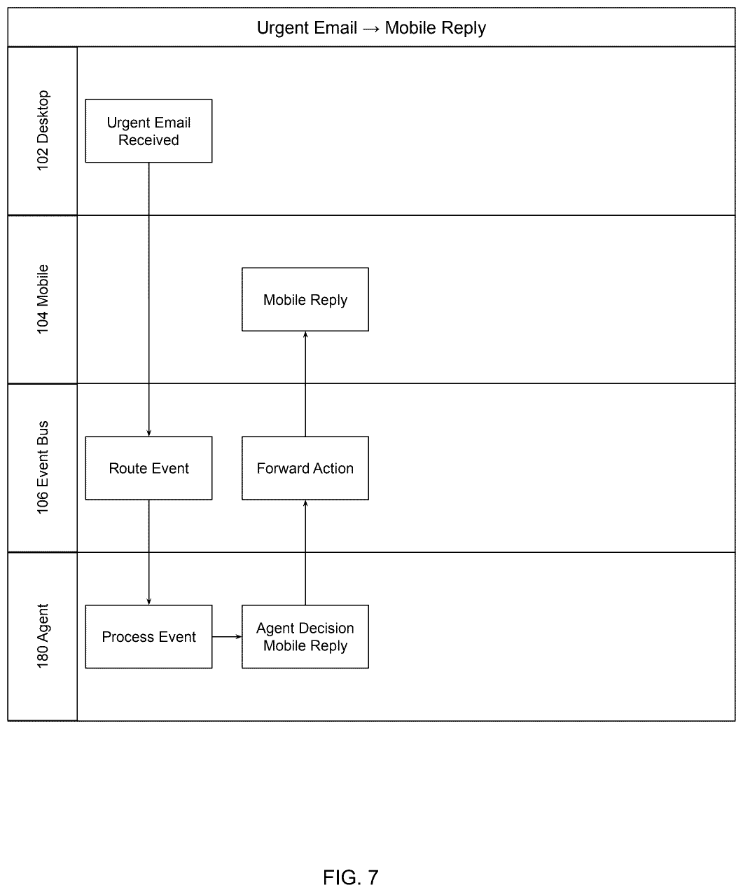

FIG. 8 is a flowchart of a method for training and deploying a user-imitative agent, including monitoring, synchronizing and preprocessing, augmenting, training, deploying, simulating, capturing feedback, and updating.

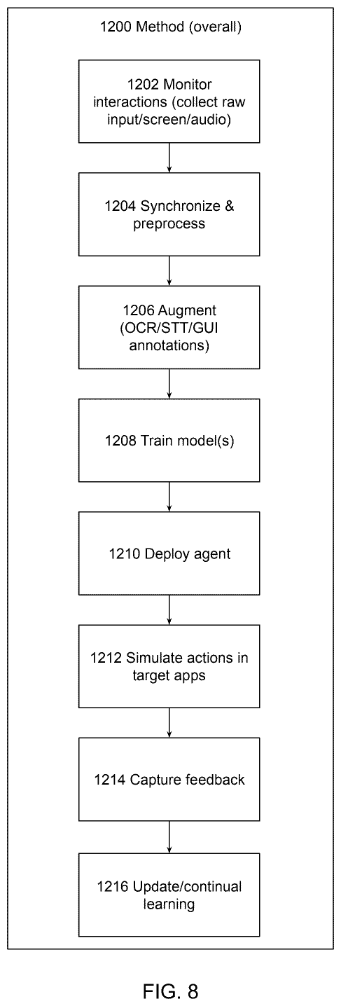

FIG. 9 is a block diagram of a privacy redaction pipeline in which OCR and speech-to-text outputs are filtered to remove sensitive content before dataset storage.

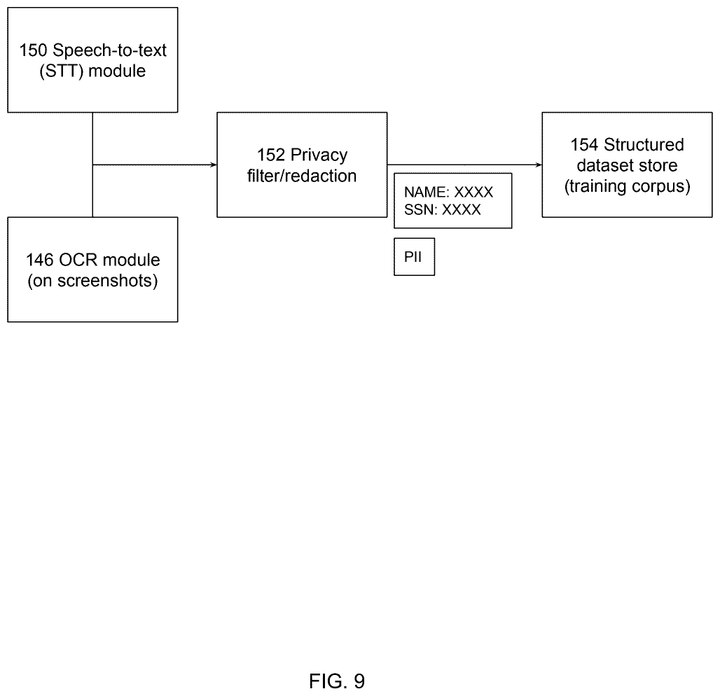

FIG. 10 is a cloud infrastructure diagram showing containerized deployment of services, a distributed training cluster, and a model registry under an orchestration layer.

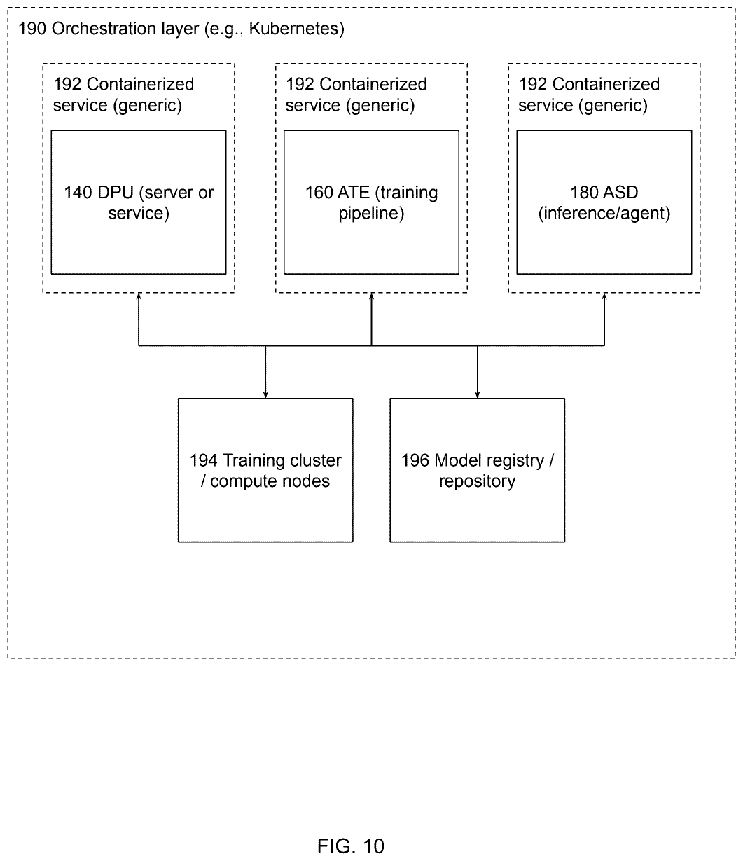

FIG. 11 is a diagram of a non-transitory computer-readable medium storing instructions which, when executed, cause the MLS functions to be performed.

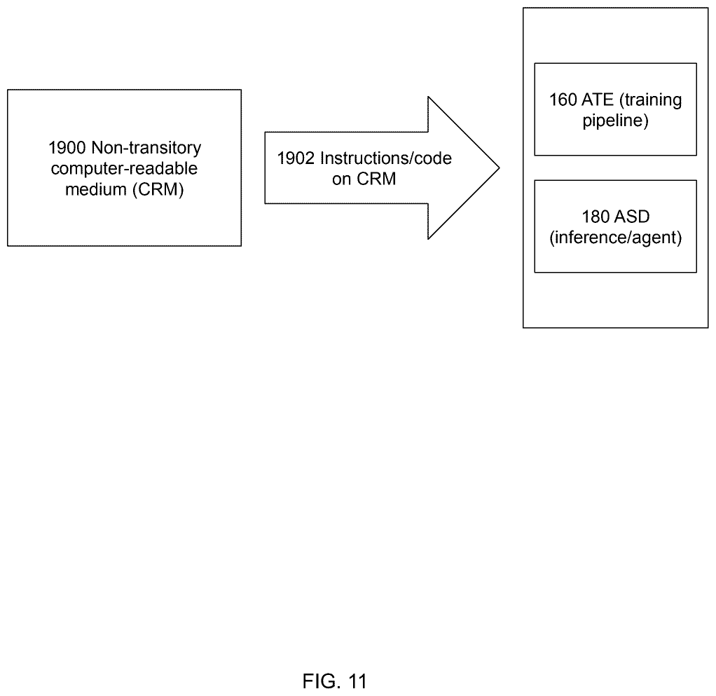

FIG. 12 is a mock user-interface view showing GUI element annotation with OCR tokens, element bounding boxes, and alignment to a time-synchronized event timeline.

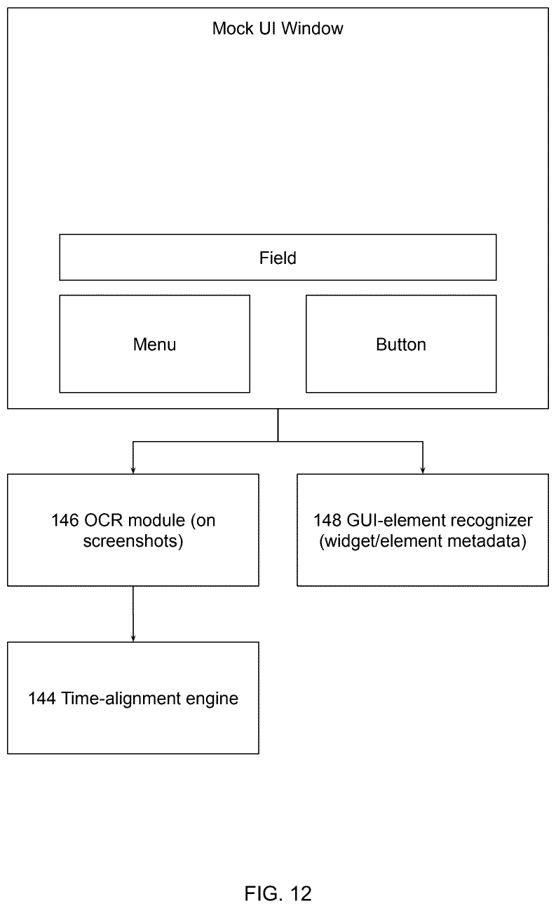

### DETAILED DESCRIPTION OF THE INVENTION

### A. Overview

In one embodiment, the Monitored Learning System (MLS) includes four cooperating components: the UIM, DPU, ATE, and ASD. The UIM captures multi-modal interaction data; the DPU produces synchronized, structured training data with textual and semantic annotations; the ATE trains one or more machine-learning models (e.g., sequence models fused with visual and textual encoders); and the ASD executes model-predicted actions to simulate user behavior for automation of routine and semi-novel tasks.

### B. Computing Environment and Deployment

The MLS may operate on general-purpose computing systems including CPUs, GPUs, memory, non-volatile storage, and network interfaces. The UIM runs on endpoints (e.g., desktops, laptops, mobile devices, thin clients) with OS-level hooks for input capture and display capture. The DPU, ATE, and ASD may run on a local server or in cloud infrastructure; containerization and orchestration (e.g., microservices) may be used for scalability and fault isolation.

### C. User Interaction Monitor (UIM)

The UIM records: (i) GUI events (mouse down/up, move, key down/up) with timestamps and application/window identifiers; (ii) screen content via full-frame screenshots, window-scoped captures, or event-triggered region captures; and (iii) audio from microphones and/or system audio (subject to user permissions and privacy filters). Sampling and buffering strategies ensure temporal coherence (e.g., event times in milliseconds; frame timestamps; audio sample clocks).

On multi-device deployments, each device's UIM streams capture records to a networked buffer or message bus, embedding device IDs and local monotonic clocks; a clock-sync process (e.g., via periodic beacons) allows the DPU to align events and frames from disparate devices into a unified timeline.

### D. Data Processing Unit (DPU)

The DPU aggregates streams into sessions and performs preprocessing including: deduplication, noise filtering, event coalescing (e.g., pointer drags), and time-sequencing across modalities. The DPU may apply OCR to extract on-screen text (titles, labels, menu items) and GUI element recognition to annotate widgets (buttons, fields, dialogs) interacted with by the user. Audio is transcribed to text and diarized where feasible to isolate the user's voice.

The DPU may include a privacy filter that masks or omits sensitive content (password fields, personally identifiable information, confidential text regions, and protected audio segments) prior to model training and storage. The filter can use rule-based detectors (e.g., field type heuristics) and ML-based classifiers (e.g., PII recognizers) to redact content while retaining structural context.

The processed dataset is stored with schema including: session_id; device_id; event_type; event_payload; screenshot_id; OCR tokens with bounding boxes; GUI element metadata; audio transcript tokens with timing; and alignment indices mapping events to visible UI elements and transcript spans.

### E. AI Training Engine (ATE)

The ATE trains models that map a current state—consisting of recent GUI events, the contemporaneous screen representation, and textual context (from OCR and transcripts)—to predicted next actions or policies. Architectures may include: (i) sequence models (e.g., transformers) over action tokens; (ii) vision encoders over screen images (optionally with layout/element embeddings); and (iii) multi-modal fusion layers that condition action predictions on fused visual-textual-event context.

In some embodiments, supervised learning from user logs is augmented with imitation learning and/or reinforcement learning in sandboxed environments to improve robustness under variation (e.g., shifted window positions, updated UI skins, or new but analogous data tables). The objective may optimize task-level success proxies (completion markers), latency, or error rates as measured in simulated and/or shadow-execution trials.

### F. AI Simulation & Deployment (ASD)

The ASD instantiates the learned policy as an automation agent that can: launch applications; focus windows; locate target UI elements (by object/label/visual match); generate input sequences (clicks, drags, text entry); and orchestrate multi-step tasks. The ASD may expose an API and scheduler for user-initiated or predicted routine triggers (e.g., “prepare weekly report” when a dataset appears). Agent actions are monitored and logged for feedback.

The system may operate cross-device, for example detecting that a desktop email mentions an urgent message and initiating a mobile response workflow consistent with the user's historical pattern. The ASD can coordinate with per-device shims that translate abstract actions (e.g., “reply to sender with template T and attach latest spreadsheet”) into device-specific UI manipulations or service API calls.

### G. Closed-Loop Learning and Feedback

During deployment, the ASD's executed interactions and resulting system states are captured by the UIM and returned to the DPU to create continual learning datasets. The ATE periodically retrains or fine-tunes models with these interaction traces, improving accuracy and adapting to new applications, layouts, or data distributions.

### H. Best Mode (Exemplary Implementation Details)

In a best-mode implementation, the UIM samples screenshots at 2-5 Hz baseline and on event triggers (e.g., window change, menu open), records input events with ≤1 ms resolution, and captures microphone audio at 16 kHz mono. The DPU performs OCR on screenshots (e.g., window title bars, menus, dialogs) and aligns OCR tokens to UI element bounding boxes; audio is transcribed and timestamped at sentence or phrase granularity.

The ATE uses a transformer-based sequence-to-action model that ingests: (a) a sliding window (e.g., last 5-15 seconds) of event tokens, (b) a visual embedding of the latest screen frame (optionally with element masks), and (c) tokenized OCR/transcript text. The output predicts the next action type and parameters (target element, coordinates, text content), with a calibration head estimating confidence. Fine-tuning with imitation learning on counterfactual screen perturbations improves robustness.

The ASD executes actions through OS-level input synthesis (secured by user consent) and/or application APIs when available. A policy guardrail checks preconditions (e.g., target element still visible and labeled) before committing actions and can fall back to asking the user or deferring execution when confidence is below a threshold.

### I. Privacy, Security, and Compliance

The MLS enforces explicit user opt-in, local redaction of sensitive fields prior to transmission, and role-based access to stored interaction logs. Data retention policies, encryption in transit and at rest, and per-application capture controls can be configured to satisfy organizational and regulatory requirements.

### J. Advantages

The disclosed MLS (i) fuses multi-modal signals (events, vision, audio) for richer context, (ii) learns user-specific policies that generalize to new instances of tasks, (iii) scales across devices and applications, and (iv) improves autonomously through a closed learning loop—all of which overcome limitations of script-based RPA and screenshot-only macro tools.

### K. Definitions

As used herein, “screen content data” includes raster images, window-bounded captures, and/or element-level render representations; “audio data” includes user speech, meeting audio, or system audio within configured scopes; “simulate the user's behavior” means to perform sequences of actions such that end results substantially match those historically produced by the user under analogous conditions.

### L. Alternative Embodiments

Embodiments may omit audio capture while retaining OCR-based context; alternatively, embodiments may rely more heavily on application APIs for action execution rather than OS-level input synthesis. Embodiments may also provide explainability by emitting rationales (e.g., top textual cues or element labels) alongside predicted actions.

1. A system for learning and simulating user interactions, comprising: a User Interaction Monitor executable on one or more computing devices and configured to capture user interaction data from a user's activities across a plurality of software applications and devices, the interaction data including at least graphical user interface events, keystrokes, pointer movements, screen content data, and audio data; a Data Processing Unit communicatively coupled to the User Interaction Monitor and configured to aggregate and preprocess the captured user interaction data to produce training data, wherein preprocessing includes time-sequencing events, filtering noise, extracting textual content from screen images by optical character recognition and converting audio data into text transcripts; an AI Training Engine configured to train one or more machine-learning models using the training data to create a learned user-interaction model that predicts user actions or preferences based on observed patterns of the user's behavior and generalizes the user's workflows across the plurality of applications; and an AI Simulation and Deployment module configured to utilize the learned user-interaction model to simulate the user's behavior by executing predicted actions on one or more target applications in accordance with the model, thereby performing tasks on behalf of the user.

2. The system of claim 1, wherein the User Interaction Monitor comprises an event logger that hooks into operating system input application programming interfaces to record mouse clicks and keystrokes with application context and a screen capture component that periodically or in response to events records screenshots or pixel data from each active application window.

3. The system of claim 1, wherein the audio data includes audio output of meetings or the user's voice commands and the Data Processing Unit further comprises a speech recognition module that generates text transcripts from the audio data such that spoken instructions or remarks by the user during the interactions are included as contextual features in the training data.

4. The system of claim 1, wherein the Data Processing Unit is configured to perform object recognition on captured screen content to identify graphical user interface elements interacted with by the user by labeling screenshot images with element metadata including window titles, button labels, and form fields as part of the training data.

5. The system of claim 1, wherein the AI Training Engine employs a deep-learning model selected from the group consisting of a recurrent neural network or transformer that processes sequences of user actions to predict subsequent actions, a convolutional neural network that processes screen images to encode visual context of the user's screen, and a multi-modal neural network that fuses image, text, and event inputs to learn correlations between what the user sees, does, and says.

6. The system of claim 1, wherein the AI Training Engine is further configured to use reinforcement learning or imitation learning to refine the learned user-interaction model by simulating the user's actions in a training environment and receiving feedback, thereby improving the model's ability to achieve the same goals as the user under varying conditions.

7. The system of claim 1, wherein the AI Simulation and Deployment module is configured to deploy the learned model as a personal digital assistant that runs on the user's devices or on a cloud service to autonomously perform multi-step tasks on behalf of the user including launching applications, clicking user-interface elements, and entering text, and wherein the module includes a scheduler for triggering actions on user request or when the model predicts a routine task should be done.

8. The system of claim 1, wherein the User Interaction Monitor on each of the plurality of devices streams captured interaction data in real time to the Data Processing Unit via a network and the system further comprises a central event bus or message queue that buffers and synchronizes the multi-device event streams.

9. The system of claim 1, wherein the Data Processing Unit includes a privacy filter that sanitizes or anonymizes sensitive data by removing passwords, personal identifiers, or confidential content from captured screen text or audio before using the data for training.

10. The system of claim 1, wherein the AI Simulation and Deployment module further comprises a feedback logger that monitors the automation agent's performance of tasks and sends resulting interaction data back into the Data Processing Unit such that the system forms a closed learning loop.

11. The system of claim 1 implemented in a cloud computing environment wherein the AI Training Engine and the AI Simulation and Deployment module are containerized services orchestrated by a container management system and model training jobs are distributed across a cluster of nodes for scalability.

12. A computer-implemented method for training an AI agent to mimic a user's computing behavior, comprising monitoring a user's interactions on at least one computing device across multiple applications to collect raw interaction data comprising timestamped user inputs, periodic screenshots of the user's interface, and ambient audio recordings during the interactions; processing the collected data by synchronizing inputs with corresponding screenshots, extracting textual and structural information from each screenshot including recognizing graphical user interface elements and reading on-screen text, and transcribing spoken commands or comments from the audio recordings into text; training at least one machine-learning model on the processed data such that the model learns temporal patterns and context correlations in the user's behavior and, given a current state comprising recent user inputs, visible screen content, and context, predicts one or more next user actions; and deploying the trained model to operate as an automated agent by supplying the model with live input data from a target computing environment and causing the agent to execute predicted user actions to perform a task imitatively consistent with the user's past behavior.

13. A non-transitory computer-readable medium storing instructions which, when executed by one or more processors, cause performance of the method of claim 12.
